(19) United States
(12) Patent Application Publication
(10) Pub. No.: US 2026/0142712 A1
(43) Pub. Date: May 21, 2026

(54) METHODS AND APPARATUSES FOR SIDELINK BEAM ALIGNMENT

(71) Applicant: TOYOTA JIDOSHA KABUSHIKI KAISHA, Toyota-shi, Aichi-ken (JP)

(72) Inventors: Daniel MEDINA, Munchen (DE); Nuno KIILERICH PRATAS, Gistrup (DK); Torsten WILDSCHEK, Gloucester (GB); Ling YU, Kauniainen (FI); Jun TAN, Glenview, IL (US); Takayuki SHIMIZU, Mountain View, CA (US); John KENNEY, Mountain View, CA (US); Onur ALTINTAS, Mountain View, CA (US); Hongsheng LU, Mountain View, CA (US); Chang-Yi LUO, Tokyo (JP)

(73) Assignee: TOYOTA JIDOSHA KABUSHIKI KAISHA, Toyota-shi, Aichi-ken (JP)

(21) Appl. No.: 19/117,180

(22) PCT Filed: Sep. 15, 2023
(86) PCT No.: PCT/JP2023/033698

§ 371 Date: Mar. 31, 2025

Related U.S. Application Data
(60) Provisional application No. 63/377,539, filed on Sep. 29, 2022.

(51) Int. Cl. H04B 7/06

(52) U.S. Cl. CPC H04B 7/06954

(57) ABSTRACT

Disclosed are methods, apparatuses, and systems for beam alignment in a sidelink communication. The apparatuses include a first UE that is configured to: receive, from a second UE, a first radio signal using at least one first antenna; determine a first direction associated with the received first radio signal based on an estimated angle-of-arrival of the received first radio signal at the first UE; select a beam among a plurality of beams for a communication with the second UE based on the determined first direction; and transmit, to the second UE, a second radio signal on the selected beam using at least one second antenna.

### CROSS-REFERENCE TO RELATED PATENT APPLICATION

This application claims the benefit of U.S. Provisional Application No. 63/377,539, filed on Sep. 29, 2022, entitled “Sidelink beam alignment in V2X communication,” the entirety of which is incorporated by reference herein.

### TECHNICAL FIELD

Apparatuses and methods consistent with the present disclosure relate generally to communications, more specifically, methods, systems, and devices for beam alignment in a sidelink communication.

### BACKGROUND ART

Sidelink communication technology enables direct communication between two or more devices, for example, two or more vehicles in a vehicle-to-everything (V2X) communication. Some sidelink communications, for example, sidelink communications that require high data rates, prefer transmission and reception of data using high frequency radio signals. But high frequency radio signals suffer from high path loss and thus limit the communication range between devices. Beamforming with narrow beams may provide compensation for the path loss. Therefore, beamforming is useful in high frequency operation in sidelink communications. But beamforming between two vehicles in a sidelink communication is usually challenging, especially when the two vehicles are moving. Systems and methods for efficient and accurate sidelink beamforming are desired.

### SUMMARY OF INVENTION

According to some embodiments of the present disclosure, there is provided a first user equipment (UE). The first UE includes a memory storing an instruction, and a processor configured to execute the instruction stored in the memory to: receive, from a second UE, a first radio signal using at least one first antenna; determine a first direction associated with the received first radio signal based on an estimated angle-of-arrival of the received first radio signal at the first UE; select a beam among a plurality of beams for a communication with the second UE based on the determined first direction; and transmit, to the second UE, a second radio signal on the selected beam using at least one second antenna.

According to some embodiments of the present disclosure, there is provided a method for a first UE in a sidelink communication. The method includes: receiving, from a second UE, a first radio signal using at least one first antenna; determining a first direction associated with the received first radio signal based on an estimated angle-of-arrival of the received first radio signal at the first UE; selecting a beam among a plurality of beams for a communication with the second UE based on the determined first direction; and transmitting, to the second UE, a second radio signal on the selected beam using at least one second antenna.

According to some embodiments of the present disclosure, there is provided a non-transitory computer-readable medium storing instructions that are executable by one or more processors of a first UE in a sidelink communication to perform a method. The method includes: receiving, from a second UE, a first radio signal using at least one first antenna; determining a first direction associated with the received first radio signal based on an estimated angle-of-arrival of the received first radio signal at the first UE; selecting a beam among a plurality of beams for a communication with the second UE based on the determined first direction; and transmitting, to the second UE, a second radio signal on the selected beam using at least one second antenna.

### BRIEF DESCRIPTION OF DRAWINGS

FIG. 1 is a schematic diagram illustrating a sidelink beamforming in a communication system, consistent with some embodiments of the present disclosure.

FIG. 2 is a schematic diagram illustrating sidelink beamforming based on estimation of angle-of-arrival of sidelink signals in the communication system of FIG. 1, consistent with some embodiments of the present disclosure.

FIG. 3 is a schematic diagram illustrating angle-of-arrival estimation using two FR1 omnidirectional antennas disposed on a UE, consistent with some embodiments of the present disclosure.

FIG. 4 is a schematic diagram illustrating determining FR1 angle-of-arrival with respect to FR2 antenna orientation, consistent with some embodiments of the present disclosure.

FIG. 5 is a schematic diagram illustrating an exemplary test setup including two UEs and a circular antenna array to detect directional transmissions from one of the UEs, consistent with some embodiments of the present disclosure.

FIG. 6 is a schematic diagram illustrating another exemplary test setup including two UEs and a circular antenna array to detect directional transmissions from one of the UEs, consistent with some embodiments of the present disclosure.

FIG. 7 is a flow chart illustrating a method for beam alignment in a sidelink communication, consistent with some embodiments of the present disclosure.

FIG. 8 is a flow chart illustrating a method for detecting directional transmissions, consistent with some embodiments of the present disclosure.

FIG. 9 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

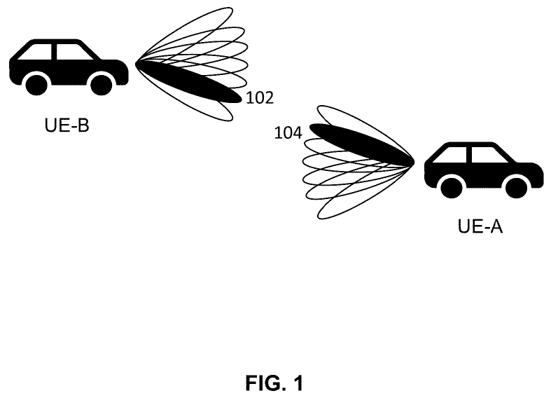

FIG. 1 is a schematic diagram illustrating a sidelink beamforming in a communication system, consistent with some embodiments of the present disclosure. Referring to FIG. 1, a communication system 100 includes a first UE (UE-A) and a second UE (UE-B) that communicate with each other via a sidelink communication. For example, the sidelink communication may be a vehicle-to-everything (V2X) communication and both the UE-A and the UE-B are vehicles. For example, the UE-B may be a transmitter (Tx) UE that is configured to or programmed to transmit signals or data to the UE-A and/or other nodes (not shown) in the communication system 100. The other nodes may be a network node (e.g., a base station), a road side unit, a relay node, or other UEs in the communication system 100. The UE-A may be a receiver (Rx) UE that is configured or programmed to receive signals or data transmitted from the UE-B and/or the other nodes in the communication system 100.

Referring to FIG. 1, the sidelink communication between the UE-A and the UE-B may be a beam-based communication. In this case, a sidelink beamforming is used so that a beam from UE-B (the oval 102 filled with the black color) and a beam from UE-A (the oval 104 filled with the black color) can be aligned. The term “beam alignment” and the term “beamforming” are used interchangeably in this disclosure. The alignment of the beams at UE-B and the UE-A may increase communication range, achievable data rates on the sidelink, and overall system spectral efficiency.

Referring to FIG. 1, both the UE-A and the UE-B may be located at a low elevation, and both the UE-A and the UE-B may be moving. Also, in sidelink, each UE communicates with one or more UEs. These features are different from an uplink/downlink formed by a UE and a base station (e.g., gNB) in which one end of the link (base station) typically does not move and is located at a higher elevation than the other end of the link (UE). Also, in uplink/downlink communication, each UE communicates with the base station only. Due to the differences, the sequential beam alignment procedure used in beamforming between a base station and a UE may not be applicable to the sidelink beamforming between the UE-A and the UE-B. Moreover, even if the procedure used in beamforming between a base station and a UE can be applied to the sidelink beamforming, because the procedure performs exhaustive searches for the best beam pair, it may be slow and may incur significant overhead for the sidelink beamforming. At least some embodiments of the present disclosure address the above-noted issues in sidelink beamforming.

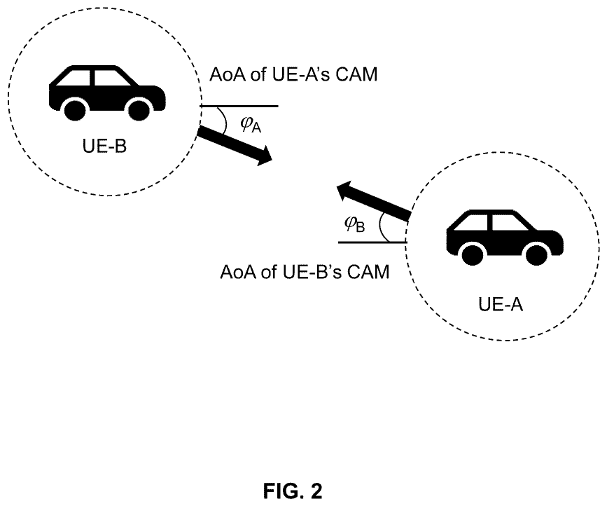

FIG. 2 is a schematic diagram illustrating sidelink beamforming based on estimation of angle-of-arrival of sidelink signals in the communication system of FIG. 1, consistent with some embodiments of the present disclosure. Referring to FIG. 2, the UE-A and the UE-B may periodically broadcast sidelink signals, for example, cooperative awareness messages (CAMs) or basic safety messages (BSMs). The CAMs or the BSMs may include information related to a transmitting UE (the UE-A or the UE-B), for example, a current location, a velocity, and a heading of the transmitting UE. Such broadcast messages may be transmitted using omnidirectional antennas in the intelligent transportation systems (ITS) band (e.g., 5.9 GHz for USA, EU, China, etc., and 760 MHz for Japan). These frequency bands correspond to the frequency range 1 (FR1 ) in the 3rd Generation Partnership Project (3GPP) standard. The frequency range of FR1 from 410 to 7125 MHz. The UE-A or the UE-B may be equipped with one or more omnidirectional antennas for reception of FR1 signals (e.g., CAMs), and may be able to estimate one or more angle(s)-of-arrival (AoA) of a received FR1 signals. As used in the present disclosure, the term “AoA” includes direction(s)-of-arrival (DoA), and the terms AoA and DoA are used interchangeably in this disclosure. In some embodiments, as shown in FIG. 2, the UE-B transmits CAMs omnidirectionally, and the UE-A determines an angle-of-arrival (φ_{B}) of an incoming CAM transmitted from the UE-B. Similarly, the UE-A transmits CAMs omnidirectionally, and the UE-B determines an angle-of-arrival (φ_{A}) of an incoming CAM transmitted from the UE-A. The methods for determining an angle-of-arrival are well-known in art. For the sake of brevity, descriptions of the methods for determining an angle-of-arrival are omitted here.

In some embodiments, the content of the received CAM (e.g., a location of the UE-A or a location of the UE-B) may be used to resolve any ambiguities (e.g., front/rear or right/left ambiguities) in estimating an angle-of-arrival. For example, the CAM broadcasted from the UE-A and received by the UE-B may include location information of UE-A so that UE-B may use the location information in determining the angle-of-arrival (φ_{A}) of the incoming CAM.

In some embodiments, the estimated angle-of-arrival is used for selecting a beam for directional transmission or reception of a higher frequency beam, for example, an FR2 beam. The frequency range of FR2 can be two frequency sub-ranges: FR2-1 from 24250 to 52600 MHz and FR2 -2 from 52600 to 71000 MHz. For example, the UE-B may use the estimated angle-of-arrival (φ_{A}) of the incoming CAM to select a beam for directional transmission of signals to the UE-A using a directional antenna (e.g., a phased array).

At least some embodiments of the disclosed methods allow for fast and accurate sidelink beam alignments without exhaustive searches among all possible beam pairs, which would be slower and incur higher overhead. Also, compared to schemes relying solely on location information (e.g., zones or coordinates) for sidelink beam alignments, at least some embodiments of the disclosed method utilize estimated angle-of-arrival, thus leading to increased accuracy and enabling beam alignment even in non-line-of-sight (NLOS) scenarios.

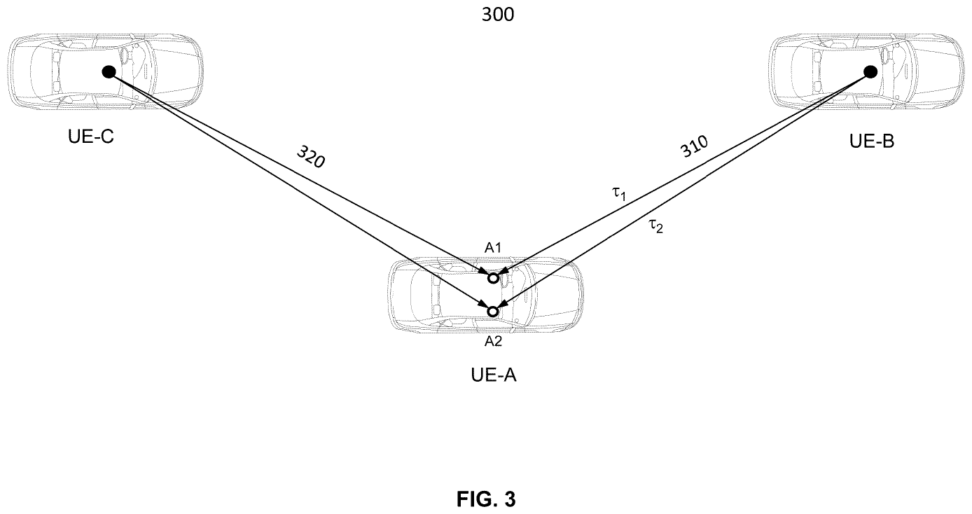

In some embodiments, the UE-A and/or the UE-B may be equipped with multiple FR1 omnidirectional antennas or multiple antenna panels so that the angle-of-arrival estimation of FR1 signals can be performed using multiple FR1 omnidirectional antennas or antenna panels, as discussed below in connection with FIG. 3.

While the exemplary embodiments in the present disclosure relate to FR1 and FR2 communication, the application of the disclosed methods are not so limited. The methods described in this disclosure can be applied to any frequency bands, including the frequency bands used in current sidelink communications, and the frequency bands used in future generation (6^{th} generation (6G), 7^{th} generation (7G), or any future generation) sidelink communications. The methods described in this disclosure can also be applied to other systems, for example, downlink/uplink or wireless local area network, or any other system that complies with other standards (e.g., IEEE standards).

FIG. 3 is a schematic diagram illustrating angle-of-arrival estimation using two FR1 omnidirectional antennas disposed on a UE, consistent with some embodiments of the present disclosure. Referring to FIG. 3, a communication system 300 includes a first UE (UE-A), a second UE (UE-B), and a third UE (UE-C) that communicate with each other via a sidelink communication. For example, the sidelink communication may be a V2X communication and the UE-A, the UE-B, and the UE-C are vehicles. FIG. 3 illustrates a top view of the vehicles. UE-A may receive FR1 signals (e.g., CAM) transmitted from UE-B and UE-C using two FR1 omnidirectional antennas (A1, A2). Each of the two FR1 omnidirectional antennas is disposed close to a a respective side of the vehicle. In some embodiments, the configuration of the two FR1 omnidirectional antennas (A1, A2) may be in the form of a 2-element linear array of antennas. Generally, the phase of the received FR1 signal at the antenna A1 is different from the phase of the received FR1 signal at the antenna A2 due to the different path lengths and corresponding propagation delays (τ₁, τ₂) . In some embodiments, by comparing the phases of the received FR1 signals at each antenna, the UE-A may estimate an azimuthal angle in the (x, y)-plane corresponding to the direction in which the source (the UE-B or the UE-C) of the transmitted FR1 signal is located.

There may be multiple angles from which a transmitted FR1 signal may arrive at the different antennas with the same phase difference. For example, as shown in FIG. 3, a signal (310) transmitted from the UE-B may be received at the antenna Al of the UE-A with the same phase difference as a signal (320) transmitted from UE-C, due to the radial symmetry around the A1-A2 axis. Thus, the UE-A may not be able to distinguish the signal (320) incoming from the left side of the A1-A2 axis and the signal (310) incoming from the right side of the A1-A2 axis. This may cause a left/right or longitudinal ambiguity. If A1 and A2 were placed along the UE-A's longitudinal axis, there would be a similar ambiguity but in the transversal direction. At least some embodiments of the present disclosure resolve such ambiguities by using the location information contained in the received FR1 signals. For example, the CAM received from UE-B may include information about the geographic coordinates (latitude, longitude, altitude) of a current location of the UE-B. For another example, sidelink control information (SCI) received from UE-B may include information about a zone identification (ID) corresponding to a current location of the UE-B. By combining angle-of-arrival estimation with the location information received from the UE-B and/or the UE-C, the UE-A may achieve an improved angular precision in estimating angle-of-arrival.

In some embodiments, the UE-A may use more than two FR1 omnidirectional antennas to receive FR1 (e.g., CAM) signals. The number of the FR1 omnidirectional antennas can be any number. For example, the UE-A may use four omnidirectional antennas to receive the FR1 signals transmitted from UE-B. The four omnidirectional antennas may be disposed on the rooftop of the UE-A, each at a corner on the roof of the UE-A. The four rooftop corner antennas may form a 2×2 planar array of antennas. At least some embodiments of the present disclosure resolve the above-mentioned ambiguities (e.g., the longitudinal ambiguity) by using more than two FR1 antennas, without using the location information of the UE-B or the UE-C.

In some embodiments, the UE-A may perform FR2 beam selection based on estimated angle-of-arrival of the FR1 signals. Once the UE-A has an estimate of the direction or angle (at least an azimuthal angle) from which FR1 signals transmitted by a signal source (e.g., the UE-B or the UE-C) are arriving, the UE-A may use this estimate to select a Tx or Rx beam pointing in the corresponding direction for directional communication with the signal source (e.g., the UE-B or the UE-C) in FR2 using a directional antenna (e.g., a phased array or antenna panel). In some embodiments, the UE-A may select the Tx or Rx beam based on an implicit mapping between the directions (or angles) and the beams. The rules for such mapping may be pre-defined, or pre-configured at the UE-A, or configured by a network node. In some embodiments, prior to beam selection, the UE-A may analyze the estimated angle-of-arrival (or direction-of-arrival) to determine a direction with respect to the coordinate system of the directional antenna (e.g., relative to the FR2 phased array). In some embodiments, the determination is obtained via pre-configuration during the device manufacturing or via calibration.

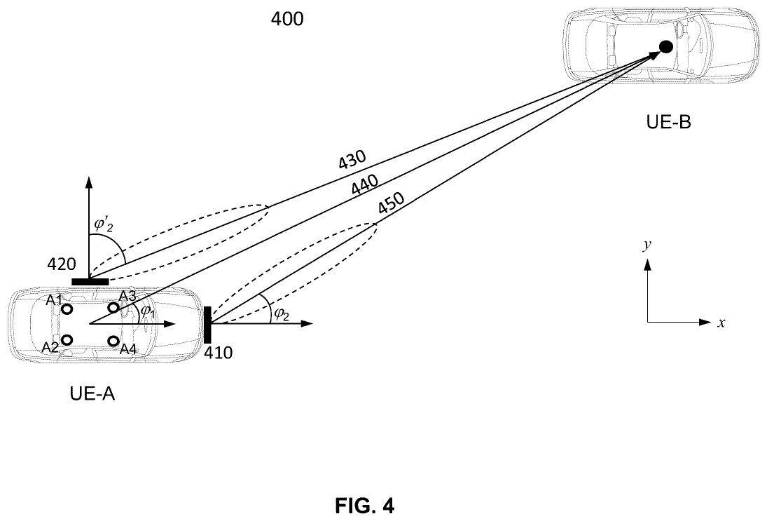

FIG. 4 is a schematic diagram illustrating a determination of FR1 angle-of-arrival with respect to FR2 antenna orientation, consistent with some embodiments of the present disclosure. Referring to FIG. 4, a communication system 400 includes a first UE (UE-A) and a second UE (UE-B) that communicate with each other via a sidelink communication. For example, the sidelink communication may be a V2X communication and the UE-A and the UE-B are vehicles. UE-A may receive FR1 signals (e.g., CAM) transmitted from UE-B using four FR1 omnidirectional antennas (A1 to A4). The four FR1 omnidirectional antennas A1-A4 are disposed on the rooftop of the UE-A, each at a corner on the rooftop. In some embodiments, the four rooftop corner antennas A1-A4 are considered as a 2×2 planar array of antennas.

Referring to FIG. 4, UE-A may estimate an angle-of-arrival (φ₁) of an FR1 signal transmitted from the UE-B using the 2×2 rooftop array. The angle-of-arrival (φ₁) is given with respect to the direction pointing towards the front of the vehicle (x axis). As shown in FIG. 4, UE-A also includes a directional FR2 antenna 410 located in the front bumper and a directional FR2 antenna 420 located on a side. If the FR2 antenna 410 is to be used for directional communication, the angle (φ₂) in which the beam should point, with respect to the normal vector of the FR2 phased array (x\acute{ }), is approximately the same as φ₁, especially when UE-B is located far away from the UE-A. However, if the FR2 antenna 420 to be used for directional communication, the angle (φ₂′) in which the beam should point, with respect to the normal vector of the FR2 phased array (y\acute{ }), is approximately (90-φ₁), especially when UE-B is located far away from the UE-A. At least some embodiments of the present disclosure address the effect of the different locations of the FR2 antenna by performing an analysis of the direction (or angle) determined by angle-of-arrival estimation.

For example, in some embodiments, the UE-A may perform an analysis of the angle-of-arrival observed in FR1 using the 2×2 rooftop array in FR1 to determine the direction with respect to the coordinate system of a directional antenna 410 or 420. For example, the UE-A may analyze the direction 440 observed in FR1 using the 2×2 rooftop array to take into account clockwise or counterclockwise variation at the FR2 antenna 410 or 420 to obtain the direction 450 or 430 with respect to the FR2 antenna 410 or 420. In this way, the effect of the different placements of the FR1 and FR2 antennas and the difference in distances between the vehicles are eliminated, leading to increased accuracy of the beamforming.

The exemplary embodiment described with respect to FIG. 4 includes four FR1 antennas disposed on the rooftop of the UE-A. However, the methods of the present disclosure are not so limited. The number of FR1 antenna can be any number, and the antennas can be disposed anywhere on the vehicle, for example, on sides of the vehicle. Also, FR2 antenna can be disposed anywhere on the vehicle, for example, on the rear bumper, or on the rooftop of the vehicle.

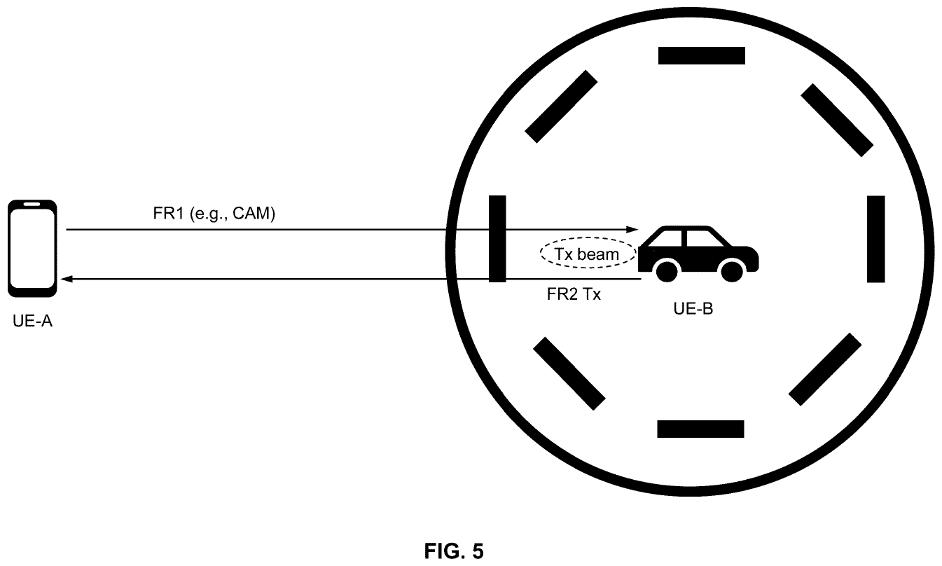

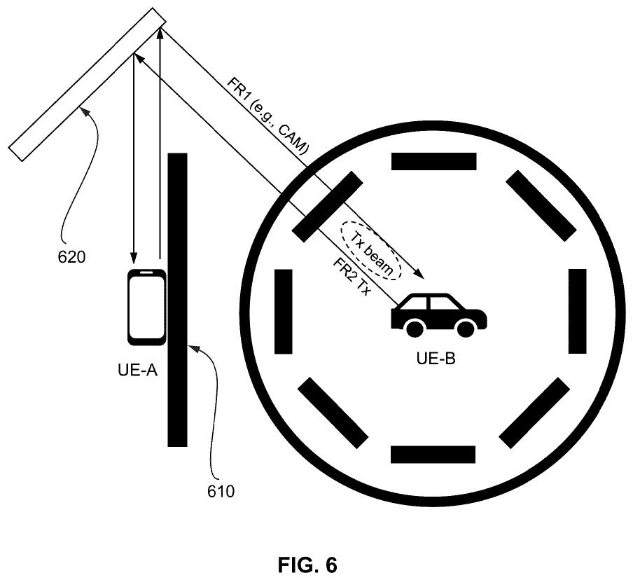

FIG. 5 is a schematic diagram illustrating a first test setup to detect directional transmissions from a device; and FIG. 6 is a schematic diagram illustrating a second test setup to detect directional transmissions from a device, consistent with some embodiments of the present disclosure. Referring to FIG. 5 and FIG. 6, each of the first test setup and the second test setup is composed of a UE-A (e.g., a cellular phone), a UE-B (e.g., a vehicle), and a circular antenna array (e.g., multiple antennas disposed on an inner wall of a ring) to detect directional transmissions from the vehicle. Compared with FIG. 5, the second test setup in FIG. 6 further includes a blocking surface 610 that blocks the line-of-sight signal between the UE-A and the UE-B, and a highly reflective surface 620 that ensures that UE-B can receive a strong non-line-of-sight component from UE-A's FR1 signal transmission.

In FIG. 5 and FIG. 6, the UE-A and the UE-B can operate in FR1 and FR2. The UE-B is the UE being tested, and the UE-A is a controllable UE or software defined radio platform. The UE-B is deployed within a ring having an array of antennas disposed on an inner wall of the ring. The array of antennas is mounted on the inner wall of the ring such that the Rx beam and/or Tx beam of the UE-B is substantially perpendicular to a respective surface of each of the antennas.

Referring to FIG. 5, in the first test setup, the UE-A transmits an FR1 signal (e.g., CAM), and the UE-B receives the FR1 signal. If the UE-B performs a narrow beam transmission in FR2 in the direction of the UE-A, without any FR2 beam alignment taking place, then this means that the UE-B was able to acquire beam alignment information from CAM received from UE-A.

Referring to FIG. 6, in the second test setup, the UE-A transmits an FR1 signal (e.g., CAM), and the UE-B receives the FR1 signal. The CAM transmitted from the UE-A is received from a non-line-of-sight (NLoS) direction at the UE-B. The CAM transmitted from the UE-A may include the location information of the UE-A. If the UE-B performs a narrow beam transmission in FR2 in the direction of arrival of the CAM transmitted from the UE-A (the NLOS component) instead of the line-of-sight (LoS), then this provides an indication that UE-B practices methods disclosed in this disclosure.

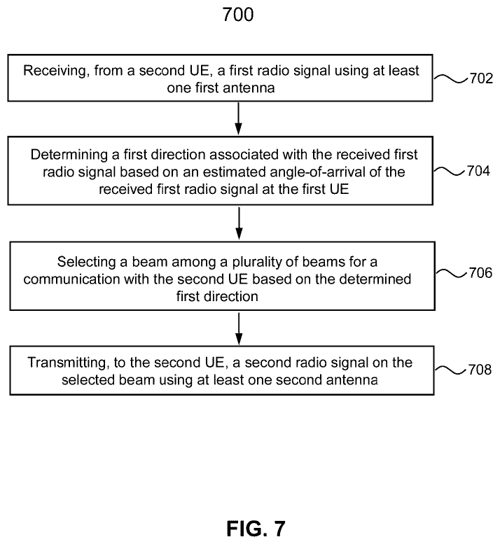

FIG. 7 is a flow chart illustrating a method 700 (e.g., for beam alignment) in a sidelink communication, consistent with some embodiments of the present disclosure. The method 700 may be performed by a UE in a sidelink communication. For example, the method 700 may be performed by the UE-A or the UE-B of FIGS. 1-4.

Referring to FIG. 7, the method 700 includes a step 702 of receiving, from a second UE, a first radio signal using at least one first antenna. For example, a first UE, such as the UE-A of FIGS. 1-4, may receive a first radio signal from a second UE, such as the UE-B of FIGS. 1-4. In an embodiment, the first radio signal may be an FR1 signal (e.g., CAM or BSM). In some embodiments, the at least one first antenna may be one or more FR1 omnidirectional antennas. For example, the at least one first antenna may be a two-antenna linear array as shown in FIG. 3, or four-antenna planar array as shown in FIG. 4. The number of the FR1 omnidirectional antennas can be any number, and the shape of the array formed by the FR1 omnidirectional antennas can be any shape (linear, rectangle, square, circle, etc.). In some embodiments, the at least one first antenna can also be a single FR1 omnidirectional antenna including multiple antenna panels. In some embodiments, the first radio signal may include location information providing a current location of the second UE. The location information may be geographic coordinates (latitude, longitude, altitude) of the current location of the second UE, or a zone ID corresponding to the current location of the second UE.

The method 700 includes a step 704 of determining a first direction associated with the received first radio signal based on an estimated angle-of-arrival of the received first radio signal at the first UE. For example, the first UE (e.g., the UE-A of FIG. 4) determines the direction of incoming first radio signal (e.g., CAM) based on an estimation of angle-of-arrival of the first radio signal at the first UE. The estimated angle-of-arrival of the received first radio signal at the first UE may include at least one of: an angle between x-axis and an incoming first radio signal direction, or an angle between y-axis and the incoming first radio signal direction. In some embodiments, the estimated angle-of-arrival of the received first radio signal at the first UE may further include an angle between z-axis and the incoming first radio signal direction. In some embodiment, rather than x, y, z-axis, the first UE may choose any other reference axis. In some embodiments, the at least one first antenna may include two or more omnidirectional antennas, and the angle-of-arrival of the received first radio signal may be estimated based on a comparison of phases of the received first radio signal at the two or more omnidirectional antennas. In some embodiments, the received first radio signal may include location information of the second UE, and in determining the angle-of-arrival of the first radio signal, the first UE takes into account the location information of the second UE.

The method 700 includes a step 706 of selecting a beam among a plurality of beams for a communication with the second UE based on the determined first direction. In some embodiments, the first UE selects the beam among the plurality of beams based on a correspondence mapping between the plurality of beams and a plurality of directions of a plurality of signals incoming to the first UE. The correspondence mapping rules may be pre-defined, pre-configured at the first UE, or configured by a network node. In some embodiments, before selecting the beam among the plurality of beams, the first UE may determine a direction of the beam from the at least one second antenna with respect to a coordinate system of the at least one second antenna, based on the determined first direction associated with the received first radio signal. For example, the first UE may perform an analysis of the direction determined by angle-of-arrival estimation of the first radio signal to obtain a direction with respect to the coordinate system of the second antenna, as explained with respect to FIG. 4 above. The direction of the beam may be determined based on one or more parameters, such as the location of the second antenna at the first UE, the distance between the first UE and the second UE, etc.

The method 700 includes a step 708 of transmitting, to the second UE, a second radio signal on the selected beam using at least one second antenna. The at least one second antenna may be at least one directional antenna that communicates with the second UE using a FR2 beam. In this way, a FR2 beam based directional communication between the first UE and the second UE may be easily established with aligned beam(s).

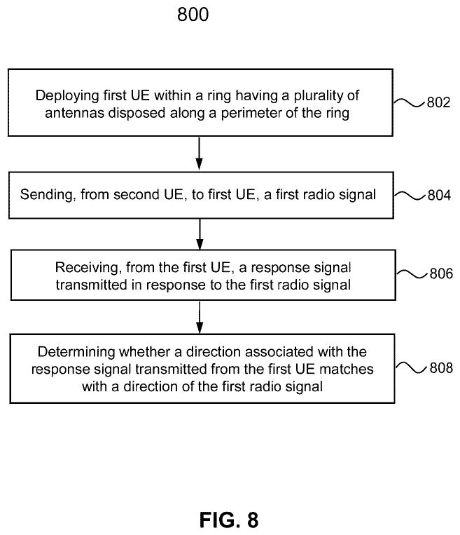

FIG. 8 is a flow chart illustrating a method 800 for detecting directional transmissions, consistent with some embodiments of the present disclosure. The method 800 may be performed by two UEs in a sidelink communication. For example, the method 800 may be performed by the UE-A and the UE-B as shown in FIG. 5 or FIG. 6.

Referring to FIG. 8, the method 800 includes a step 802 of deploying a first UE within a ring having a plurality of antennas disposed along a perimeter (inner wall) of the ring. The first UE is a UE being tested for determining whether the UE practices the method of FIG. 7. The first UE may be capable of operating in FR2 beam. The first UE may be a vehicle in a V2X communication, for example, the vehicle as shown in FIG. 5 and FIG. 6.

The method 800 includes a step 804 of sending, from a second UE, to the first UE, a first radio signal. The first radio signal may be an FR1 signal (e.g., CAM) transmitted from the second UE. The second UE may be capable of operating in FR2 beam. The second UE may be a cellular phone as shown in FIG. 5 and FIG. 6.

The method 800 includes a step 806 of receiving, from the first UE, a response signal transmitted in response to the first radio signal. In an example where the first UE practices the method of FIG. 7, upon reception of the first radio signal (e.g., CAM), the first UE determines the angle-of-arrival of the first radio signal. The first UE may further analyze the estimated direction associated with the estimated angle-of-arrival to determine a direction with respect to the coordinate system of the second antenna. The first UE may then select a beam and transmit a response signal on the selected beam using a second antenna.

The method 800 includes a step 808 of determining whether a direction associated with the response signal transmitted from the first UE matches with a direction of the first radio signal. If the direction associated with the response signal determined by one or more antennas on the inner wall of the ring matches with the direction of the first radio signal, it can be concluded that the first UE practices the method of FIG. 7.

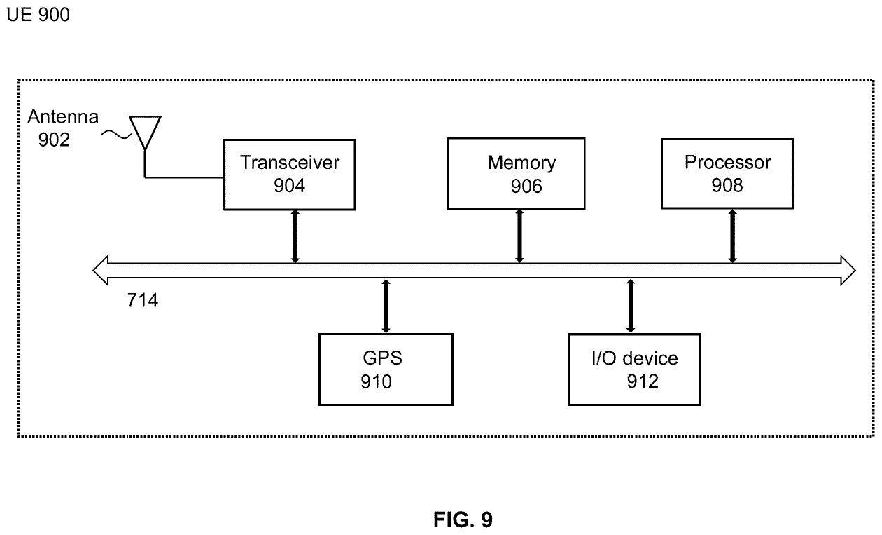

FIG. 9 is a block diagram of a UE 900, consistent with some embodiments of the present disclosure. The UE 900 may be a UE in a sidelink communication, such as the UE-A or the UE-B of FIGS. 1-6. UE 900 may be mounted in a moving vehicle or in a fixed location. UE 900 may take any form, including but not limited to, a vehicle, a component mounted in a vehicle, a laptop computer, a wireless terminal including a mobile phone, a wireless handheld device, or wireless personal device, or any other form. Referring to FIG. 9, the UE 900 may include antenna 902 that may be used for transmission or reception of electromagnetic signals to/from other nodes such as a network node (e.g., a base station), a road side unit (RSU), a relay node, a base station or other UEs. The antenna 902 can be one or more FR1 omnidirectional antennas, such as the antenna A1 and A2 of FIG. 3, or the antennas A1-A4 of FIG. 4. The antenna 902 can also be one or more FR2 antennas, such as the antenna 410 or the antenna 420 of FIG. 4. The Antenna 902 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 902 may include multiple (e.g., tens or hundreds) antenna elements and may enable multi-antenna functions such as beamforming. In some embodiments, the antenna 902 is a single antenna.

The UE 900 may include a transceiver 904 that is coupled to the antenna 902. The transceiver 904 may be a wireless transceiver at the UE 900 and may communicate bi-directionally with a base station or other UEs. For example, the transceiver 904 may receive/transmit wireless signals from/to a base station via downlink/uplink communication. The transceiver 904 may also receive/transmit wireless signals from/to another UE or RSU via sidelink communication. The transceiver 904 may include a modem to modulate the packets and provide the modulated packets to the antenna 902 for transmission, and to demodulate packets received from the antenna 902.

The UE 900 may include a memory 906. The memory 906 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 906 may store information related to identities of UE 900 and the signals and/or data received by antenna 902. The memory 906 may also store post-processing signals and/or data. The memory 906 may also store computer-readable program instructions, mathematical models, and algorithms that are used in signal processing in transceiver 904 and computations in processor 908. For example, the memory 906 may store computer-readable program instructions, mathematical models, and algorithms that are used for estimation of the angle-of-arrival of an FR1 signal (e.g., CAM). The memory 906 may further store computer-readable program instructions for execution by processor 908 to operate UE 900 to perform various functions described in this disclosure. In some examples, the memory 906 may include a basic input/output system (BIOS) which may control basic hardware or software operation such as the interaction with peripheral components or devices. In some embodiments, the memory 906 includes both LTE and NR modules. In some other embodiments, the memory 906 includes an NR module only. In some other embodiments, the memory 906 includes an LTE module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 900 may include a processor 908 that may include a hardware device with processing capabilities. The processor 908 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 908 may be implemented using a combination of devices (e.g., a combination of a DSP and a microprocessor, multiple microprocessors, one or more microprocessors in conjunction with a DSP core, or any other such configuration). The processor 908 may receive, from transceiver 904, downlink signals or sidelink signals and further process the signals. The processor 908 may also receive, from transceiver 904, data packets and further process the packets. In some embodiments, the processor 908 may be configured to operate a memory using a memory controller. In some embodiments, a memory controller may be integrated into the processor 908. The processor 908 may be configured to execute computer-readable instructions stored in a memory (e.g., the memory 906) to cause the UE 900 to perform various functions.

The UE 900 may include a global positioning system (GPS) 910. The GPS 910 may be used for enabling location-based services or other services based on a geographical position of the UE 900 and/or synchronization among UEs. The GPS 910 may receive global navigation satellite systems (GNSS) signals from a single satellite or a plurality of satellite signals via the antenna 902 and provide a geographical position of the UE 900 (e.g., coordinates of the UE 900). In some embodiment, the GPS 910 may be omitted.

The UE 900 may include an input/output (I/O) device 912 that may be used to communicate a result of signal processing and computation to a user or another device. The I/O device 912 may include a user interface including a display and an input device to transmit a user command to processor 908. The display may be configured to display a status of signal reception at the UE 900, the data stored at memory 906, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 900 may further include a machine interface 914, such as an electrical bus that connects the transceiver 904, the memory 906, the processor 908, the GPS 910, and the I/O device 912.

In some embodiments, the UE 900 may be configured to or programmed for sidelink communications. For example, the UE 900 may be a first UE in a sidelink communication, and the processor 908 may be configured to execute the instructions stored in the memory 906 to receive, from a second UE, a first radio signal using at least one first antenna; determine a first direction associated with the received first radio signal based on an estimated angle-of-arrival of the received first radio signal at the first UE; select a beam among a plurality of beams for a communication with the second UE based on the determined first direction; and transmit, to the second UE, a second radio signal on the selected beam using at least one second antenna.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ended. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred”or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated in order to explain the nature of described embodiments may be made by those skilled in the art without departing from the scope. Accordingly, the following claims embrace all such alternatives, modifications and variations that fall within the terms of the claims.

Clause 1. A first user equipment (UE) for communications, the first UE comprising:
a memory storing an instruction; and
a processor configured to execute the instruction stored in the memory to:
   receive, from a second UE, a first radio signal using at least one first antenna;
determine a first direction associated with the received first radio signal based on an estimated angle-of-arrival of the received first radio signal at the first UE;
select a beam among a plurality of beams for a communication with the second UE based on the determined first direction; and
transmit, to the second UE, a second radio signal on the selected beam using at least one second antenna.

Clause 2. The first UE of clause 1, wherein the at least one first antenna is a plurality of omnidirectional antennas and the at least one second antenna is at least one directional antenna.

Clause 3. The first UE of clause 1, wherein the communication is a directional communication between the first UE and the second UE.

Clause 4. The first UE of clause 1, wherein the processor is further configured to execute the instruction stored in the memory to:
determine, before selecting the beam among the plurality of beams, a direction of the beam from the at least one second antenna with respect to a coordinate system of the at least one second antenna, based on at least the first direction associated with the received first radio signal.

Clause 5. The first UE of clause 1, wherein the received first radio signal includes location information providing a location of the second UE.

Clause 6. The first UE of clause 5, wherein in determining the first direction associated with the received first radio transmission, the processor is further configured to execute the instruction stored in the memory to:
determine the first direction based on at least one radio measurement of the received first radio signal and the location information.

Clause 7. The first UE of clause 5, wherein the location information comprises at least one of: geographic coordinates of the second UE, or a zone ID corresponding to a current location of the second UE.

Clause 8. The first UE of clause 1, wherein the first radio signal is a Cooperative Awareness Message (CAM) or a Basic Safety Message (BSM).

Clause 9. The first UE of clause 1, wherein the first radio signal is transmitted using a FR1.

Clause 10. The first UE of clause 1, wherein the at least one second antenna is configured to communicate with the second UE using a FR2.

Clause 11. The first UE of clause 1, wherein the at least one first antenna comprises a plurality of first antennas, and the angle-of-arrival of the received first radio signal is estimated based on a comparison of phases of the received first radio signal at two or more antennas of the plurality of first antennas.

Clause 12. The first UE of clause 1, wherein the angle-of-arrival of the received first radio signal at the first UE comprises at least one of: an angle between x-axis and an incoming first radio signal direction, or an angle between y-axis and the incoming first radio signal direction.

Clause 13. The first UE of clause 12, wherein the angle-of-arrival further comprises an elevation angle at the first UE.

Clause 14. The first UE of clause 1, wherein the beam is selected among the plurality of beams based on a correspondence mapping between the plurality of beams and a plurality of directions of a plurality of signals incoming to the first UE.

Clause 15. The first UE of clause 1, wherein the first UE is a vehicle, and the at least one second antenna is a linear array of antennas disposed along a longitudinal or a transversal axis of the vehicle.

Clause 16. The first UE of clause 1, wherein the first UE is a vehicle, and the at least one first antenna is disposed on a rooftop of the vehicle.

Clause 17. A method for a first user equipment (UE) in a sidelink communication, the method comprising:
receiving, from a second UE, a first radio signal using at least one first antenna;
determining a first direction associated with the received first radio signal based on an estimated angle-of-arrival of the received first radio signal at the first UE;
selecting a beam among a plurality of beams for a communication with the second UE based on the determined first direction; and
transmitting, to the second UE, a second radio signal on the selected beam using at least one second antenna.

Clause 18. The method of clause 17, wherein the at least one first antenna is a plurality of omnidirectional antennas and the at least one second antenna is at least one directional antenna.

Clause 19. The method of clause 17, wherein the communication is a directional communication between the first UE and the second UE.

Clause 20. The method of clause 17, further comprising:
determining, before selecting the beam among the plurality of beams, a direction of the beam from the at least one second antenna with respect to a coordinate system of the at least one second antenna, at least based on the determined first direction associated with the received first radio signal.

Clause 21. The method of clause 17, wherein the received first radio signal includes location information providing a location of the second UE.

Clause 22. The method of clause 21, wherein determining the first direction associated with the received first radio signal further comprises:
determining the first direction based on at least one radio measurement of the received first radio signal and the location information.

Clause 23. The method of clause 21, wherein the location information comprises at least one of: geographic coordinates of the second UE, or a zone ID corresponding to a current location of the second UE.

Clause 24. The method of clause 17, wherein the first radio signal is a Cooperative Awareness Message (CAM) or a Basic Safety Message (BSM).

Clause 25. The method of clause 17, wherein the first radio signal is transmitted using a FR1.

Clause 26. The method of clause 17, wherein the at least one second antenna is configured to communicate with the second UE using a FR2.

Clause 27. The method of clause 17, wherein the at least one first antenna comprises a plurality of first antennas, and the angle-of-arrival of the received first radio signal is estimated based on a comparison of phases of the received first radio signal at two or more antennas of the plurality of first antennas.

Clause 28. The method of clause 17, wherein the angle-of-arrival of the received first radio signal at the first UE comprises at least one of: an angle between x-axis and an incoming first radio signal direction, or an angle between y-axis and the incoming first radio signal direction.

Clause 29. The method of clause 28, wherein the angle-of-arrival of the received first radio signal at the first UE further comprises an elevation angle at the first UE.

Clause 30. The method of clause 17, wherein the beam is selected among the plurality of beams based on a correspondence mapping between the plurality of beams and a plurality of directions of a plurality of signals incoming to the first UE.

Clause 31. The method of clause 17, wherein the first UE is a vehicle, and the at least one second antenna is a linear array of antennas disposed along a longitudinal or a transversal axis of the vehicle.

Clause 32. The method of clause 17, wherein the first UE is a vehicle, and the at least one first antenna is disposed on a rooftop of the vehicle.

Clause 33. A non-transitory computer-readable medium storing instructions that are executable by one or more processors of a first user equipment (UE) for communication, to perform a method, the method comprising:
receiving, from a second UE, a first radio signal using at least one first antenna;
determining a first direction associated with the received first radio signal based on an estimated angle-of-arrival of the received first radio signal at the first UE;
selecting a beam among a plurality of beams for a communication with the second UE based on the determined first direction; and
transmitting, to the second UE, a second radio signal on the selected beam using at least one second antenna.

1. A first user equipment (UE) for communications, the first UE comprising:
a memory storing an instruction; and
a processor configured to execute the instruction stored in the memory to:
receive, from a second UE, a first radio signal using at least one first antenna;
determine a first direction associated with the received first radio signal based on an estimated angle-of-arrival of the received first radio signal at the first UE;
select a beam among a plurality of beams for a communication with the second UE based on the determined first direction; and
transmit, to the second UE, a second radio signal on the selected beam using at least one second antenna.

2. The first UE of claim 1, wherein the at least one first antenna is a plurality of omnidirectional antennas and the at least one second antenna is at least one directional antenna.

3. The first UE of claim 1, wherein the communication is a directional communication between the first UE and the second UE.

4. The first UE of claim 1, wherein the processor is further configured to execute the instruction stored in the memory to:
determine, before selecting the beam among the plurality of beams, a direction of the beam from the at least one second antenna with respect to a coordinate system of the at least one second antenna, based on at least the first direction associated with the received first radio signal.

5. The first UE of claim 1, wherein the received first radio signal includes location information providing a location of the second UE.

6. The first UE of claim 1, wherein the first radio signal is a Cooperative Awareness Message (CAM) or a Basic Safety Message (BSM).

7. The first UE of claim 1, wherein the first radio signal is transmitted using a FR1.

8. The first UE of claim 1, wherein the at least one second antenna is configured to communicate with the second UE using a FR2.

9. The first UE of claim 1, wherein the at least one first antenna comprises a plurality of first antennas, and the angle-of-arrival of the received first radio signal is estimated based on a comparison of phases of the received first radio signal at two or more antennas of the plurality of first antennas.

10. The first UE of claim 1, wherein the angle-of-arrival of the received first radio signal at the first UE comprises at least one of: an angle between x-axis and an incoming first radio signal direction, or an angle between y-axis and the incoming first radio signal direction.

11. The first UE of claim 1, wherein the beam is selected among the plurality of beams based on a correspondence mapping between the plurality of beams and a plurality of directions of a plurality of signals incoming to the first UE.

12. The first UE of claim 1, wherein the first UE is a vehicle, and the at least one second antenna is a linear array of antennas disposed along a longitudinal or a transversal axis of the vehicle.

13. A method for a first user equipment (UE) in a sidelink communication, the method comprising:
receiving, from a second UE, a first radio signal using at least one first antenna;
determining a first direction associated with the received first radio signal based on an estimated angle-of-arrival of the received first radio signal at the first UE;
selecting a beam among a plurality of beams for a communication with the second UE based on the determined first direction; and
transmitting, to the second UE, a second radio signal on the selected beam using at least one second antenna.

14. The method of claim 13, wherein the at least one first antenna is a plurality of omnidirectional antennas and the at least one second antenna is at least one directional antenna.

15. The method of claim 13, wherein the communication is a directional communication between the first UE and the second UE.

16. The method of claim 13, further comprising:
determining, before selecting the beam among the plurality of beams, a direction of the beam from the at least one second antenna with respect to a coordinate system of the at least one second antenna, at least based on the determined first direction associated with the received first radio signal.

17. The method of claim 13, wherein the received first radio signal includes location information providing a location of the second UE.

18. The method of claim 13, wherein the at least one first antenna comprises a plurality of first antennas, and the angle-of-arrival of the received first radio signal is estimated based on a comparison of phases of the received first radio signal at two or more antennas of the plurality of first antennas.

19. The method of claim 13, wherein the angle-of-arrival of the received first radio signal at the first UE comprises at least one of: an angle between x-axis and an incoming first radio signal direction, or an angle between y-axis and the incoming first radio signal direction.

20. A non-transitory computer-readable medium storing instructions that are executable by one or more processors of a first user equipment (UE) for communication, to perform a method, the method comprising:
receiving, from a second UE, a first radio signal using at least one first antenna;
determining a first direction associated with the received first radio signal based on an estimated angle-of-arrival of the received first radio signal at the first UE;
selecting a beam among a plurality of beams for a communication with the second UE based on the determined first direction; and
transmitting, to the second UE, a second radio signal on the selected beam using at least one second antenna.
